(19) United States
(12) Patent Application Publication
(10) Pub. No.: US 2026/0044771 A1
(43) Pub. Date: Feb. 12, 2026

(54) Quantum Error Correction (QEC) using Generalized Qubits

(71) Applicant: Quantum Transistors Technology Ltd., Binyamina (IL)

(72) Inventors: Moshe-Ishay Cohen, Harish (IL); Nir Bar-Gill, Tel Aviv (IL); Elon Poem-Kalogerakis, Tsukey Yam (IL); Moshe Tordjman, Haifa (IL)

(21) Appl. No.: 19/290,383

(22) Filed: Aug. 5, 2025

Related U.S. Application Data
(60) Provisional application No. 63/679,631, filed on Aug. 6, 2024.

(51) Int. Cl. G06N 10/70

(52) U.S. Cl. CPC G06N 10/70

(57) ABSTRACT

A method for quantum error handling includes preparing one or more qubits in respective n-level quantum systems, n≥3. A quantum property of the one or more qubits is measured. An occurrence of some quantum error in the one or more qubits is detected using the measured property.

### CROSS-REFERENCE TO RELATED APPLICATIONS

This application claims the benefit of U.S. Provisional Patent Application 63/679,631, filed Aug. 6, 2024, whose disclosure is incorporated herein by reference.

### FIELD OF THE INVENTION

The present invention relates generally to quantum computing, and particularly to quantum error correction.

### BACKGROUND

A quantum computer employs principles of quantum physics to perform computations and has the potential to perform specific calculations more efficiently than conventional digital computers.

Quantum computing relies on the realization of quantum circuits, using two-level quantum systems (physical qubits) as building blocks. Physical qubits are vulnerable to environmental noise (dephasing, decoherence, relaxation), which causes errors in the expected quantum evolution (operation). It is crucial to address these effects to carry out effective quantum computations.

One approach is to use quantum error correction (QEC) methods. In that approach, quantum computations are performed using logical qubits, which are made more robust by being encoded each using some minimal number of physical qubits. Using QEC with logical qubits enables reliable quantum computations even in the presence of errors and is considered essential for constructing large-scale quantum computers that can solve practical problems.

While having redundancy in physical qubits seems effective, adding extra physical qubits to the system complicates the quantum computing hardware, potentially introducing additional sources of errors. This limitation motivates the application of QEC solutions using fewer physical qubits.

One example of such a “low redundancy” QEC solution is the five-qubit error-correcting code, regarded as the smallest quantum error-correcting code capable, at least in theory, of protecting a logical qubit from any arbitrary single-qubit error. As the name suggests, in this code, five physical qubits are used to encode each logical qubit. A minimum of three qubits is required even just to detect that some error has occurred.

### SUMMARY

An embodiment of the present invention that is described hereafter provides method for quantum error handling, the method includes preparing one or more qubits in respective n-level quantum systems, n≥3. A quantum property of the one or more qubits is measured. An occurrence of some quantum error in the one or more qubits is detected using the measured property.

In some embodiments, the method further includes encoding a logical qubit using two or more of the qubits. A single type quantum error in the logical qubit is measured. A correction is applied to the single type quantum error in the logical qubit.

In some embodiments, the method further includes encoding a logical qubit using three or more of the qubits. Any type of quantum error in the logical qubit is measured. A correction is applied to the quantum error in the logical qubit.

In an embodiment, detecting and measuring an error in the logical qubit includes applying a parity syndrome to the logical qubit.

In an embodiment, the method further includes, using classical computing circuitry, outputting a measurement result of the quantum error, and specifying correction operations required to correct the measured quantum error.

In some embodiments, the n-level systems are three-level systems of a ground state of a diamond NV center.

In some embodiments, preparing the one or more qubits includes using coherent control with microwave pulses.

In an embodiment, the method further includes, using coherent control, storing the qubits using a nuclear spin based quantum memory.

In an embodiment, the method further includes encoding a logical qubit using two of the qubits and one qubit prepared in a two-level system. Any type of quantum error in the logical qubit is measured. A correction is applied to the quantum error in the logical qubit.

There is further provided, in accordance with another embodiment of the present invention, a system for quantum error handling, the system including a first circuitry and a second circuitry. The first circuitry is configured to prepare one or more qubits in respective n-level quantum systems, n≥3. The a second circuitry configured to (i) measure a quantum property of the one or more qubits, and (ii) detect an occurrence of some quantum error in the one or more qubits using the measured property.

The present invention will be more fully understood from the following detailed description of the embodiments thereof, taken together with the drawings in which:

### BRIEF DESCRIPTION OF THE DRAWINGS

FIG. 1 is a schematic block diagram of a quantum computer including error detection and correction circuitries, in accordance with an embodiment of the invention;

FIG. 2 is a schematic energy level diagram of a qubit (3) prepared in a three-level ground-state |GS> manifold, in accordance with an embodiment of the invention;

FIGS. 3A and 3B are schematic quantum circuit diagrams illustrating, respectively, single-qubit(3) and two-qubit(3) quantum error detection schemes, in accordance with embodiments of the invention;

FIG. 4 is a schematic quantum circuit diagram illustrating two-qubit(3) QEC scheme of one type of error, in accordance with an embodiment of the invention;

FIG. 5 is a schematic block diagram illustrating a three-qubit(3) quantum error correction (QEC) scheme of any QE, in accordance with an embodiment of the invention; and

FIG. 6 is a flow chart schematically illustrating a method for QEC using qubits (n), n≥3, in accordance with an embodiment of the invention.

### DETAILED DESCRIPTION OF EMBODIMENTS

### Overview

A physical qubit is a two-state quantum-mechanical system that consists of a ground state, |GS>, and an excited state, |ES>. The ground and excited states can be implemented in various quantum mechanical systems using two-level systems. This disclosure refers to a physical qubit realized in a two-level system as “qubit(2)” to distinguish it from a two-state physical qubit realized by the disclosed technique in multi-level systems, which is referred to hereinafter as “qubit(n),” with n≥3.

Embodiments of the present invention, as described herein, propose a new QEC scheme that encodes a logical qubit (also called hereinafter “encoded state”) using generalized qubits prepared in an n-level system, where n≥3, rather than utilizing the standard two-level system QEC scheme. This expanded state space may be readily implementable in specific systems (e.g., spin-1 systems for qubit(3) and spin-3/2 for qubit(4)), providing additional resources for correcting a qubit(n).

In many quantum systems, the required hardware resources are nearly the same for qubits (n), n≥3, as for qubits (2), yielding an inherent scaling advantage; specifically:

Using qubits (3) enables full quantum error correction of a qubit(3) using total of three physical qubits(3) instead of the five-qubit(2) correction scheme mentioned above.

Using two physical qubits(3) is enough to detect and correct single type of a quantum error (QE), also called “Pauli error” X or Z) such as bit flip or phase flip.

Using a single physical qubit(3) is enough to detect that some quantum error has occurred (without specifying the nature of the error).

This consistent reduction of overhead in physical quantum elements using qubits(3) can lead to more scalable quantum computing architectures. Assuming sufficiently high-quality physical qubits(3), this can make it significantly easier to scale up a quantum processor to include many logical qubits (e.g., thousands).

This disclosure primarily discusses a non-binding example of qubits(3) realized, using coherent control, in a three-level electron spin system. The disclosed qubit(3) [symbol] has the ground state |GS [symbol] spanned by a three-level electron spin-dependent system, rather than the simple spin-up or spin-down common in physical qubit(2) schemes.

Applying nondemolition measurement on one qubit(3) indicates the correctness of the qubit(3) without harming it. A nondemolition measurement is defined hereinafter as a measurement of a quantum property of a quantum state that doesn't reveal the state itself, rather a property involving the quantum state (e.g., phase shift caused by interaction with several quantum states).

Measuring two qubits(3) in a nondemolition manner yields the required quantum operation correction that the quantum computer should apply.

In some embodiments, the disclosed multi-level QEC scheme is implemented in qubits(3) realized in solid-state chiplets, which may be based on crystal defects. For example, the qubits(3) may comprise diamond-based quantum transistors with nitrogen-vacancy (NV) color centers, which feature a three-level ground state. Such quantum transistors are described in U.S. Patent Application Publication 2024/0281690, titled “quantum transistor,” which is assigned to the assignee of the current application and is incorporated herein by reference.

In case of a qubit(2) realized using an NV center, the electronic spin state of the ground state (e.g., spin up, |↑> or down |↓>) can be determined by measuring a property of its optical emission from the transition |ES>→|GS>, such as its fluorescence intensity and/or polarization. The two more complex spin states of the qubit(3), referred to hereinafter as “|+>” or “|−>”, can similarly be determined, after manipulation (e.g., applying coherent control), by measuring optical emissions from the transition |ES>→|GS>.

### Quantum Computer Including Error Detection and Correction Circuitries

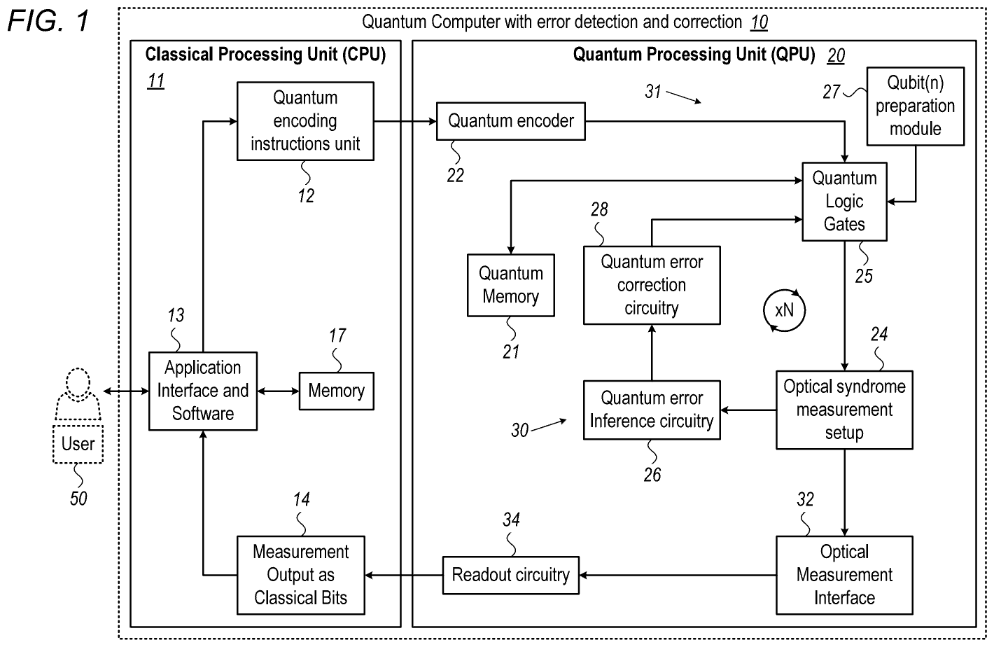

FIG. 1 is a schematic block diagram of a quantum computer 10 including error detection and correction circuitries, in accordance with an embodiment of the invention.

Functions of qubits (n) preparation and encoding are performed by a first circuitry 31 in a Quantum processing unit (QPU) 20. Functions of error detection and correction are performed by a second circuitry 30 in QPU 20.

In quantum computer 10, the component that stores and feeds any algorithm to the quantum gates is typically a classical processing unit (CPU) 11—also called hereinafter classical processing circuitry 11—having a memory 17. To this end, classical processor 11 runs the overall program (e.g., in Python-based Qiskit or Cirq).

Processor 11 translates the high-level quantum algorithm into a required quantum circuit configuration (a sequence of quantum gate operations), which is stored in memory 17 or communicated to a quantum encoder 22 by a quantum encoding instructions unit 12 as commanded by an application interface and software module 13 as a list of gate instructions.

Processor 11 may also instruct sending control signals (pulses, timings) to the quantum gate hardware (microwave generators, lasers, etc.) to manipulate qubits according to the required quantum circuit configuration.

QPU 20 converts instructions into physical actions (microwave pulses, magnetic fields, optical signals) that operate on qubits.

Thus, while qubits do the actual quantum computation in module 25, a classical system controls the timing and sequence-feeding the algorithm to the quantum gates.

In FIG. 1, a user 50 operates quantum computer 10 via a classical computer 11 comprising application interface and software module 13, which commands a quantum encoding instructions unit 12 to instruct quantum encoder 22 to prepare a quantum configuration, such as including qubit (3) initialization command, where qubit (3) preparation (e.g., initialization) is done by a qubit(3) preparation module 27, and a sequence of quantum gate operations (like Hadamard, CNOT, etc.).

In the process of quantum computation, quantum circuitry 25 (e.g., an array of quantum logic gates) manipulates amplitudes of the pre-prepared qubits(3) according to a quantum algorithm. To perform its function, quantum circuitry 25 is aided by quantum memory 21 that is capable of storing the qubits(3) without decoherence.

For QEC, an optical syndrome measurement setup 24 performs nondemolition measurements, such as optical parity measurements, on an encoded state of two or more qubits (3), to discover error in the entangled quantum state.

If a quantum error inference circuitry 26 detects an error, it triggers a quantum error correction circuitry 28 to fix the error (e.g., using microwave pulse applied to a physical qubit(3) in quantum circuitry 25). A number N≥1 of QEC cycles can be applied by QPU 20 to ensure the correction.

At the N+1 cycle the quantum state is measured by an optical measurement interface 32 and an electronic signal obtained by readout circuitry 34 is sent to a measurement output module 14, who represent the signal as classical Bits for use by the software module 13.

### Preparing a Qubit in a 3-Level Hilbert Space

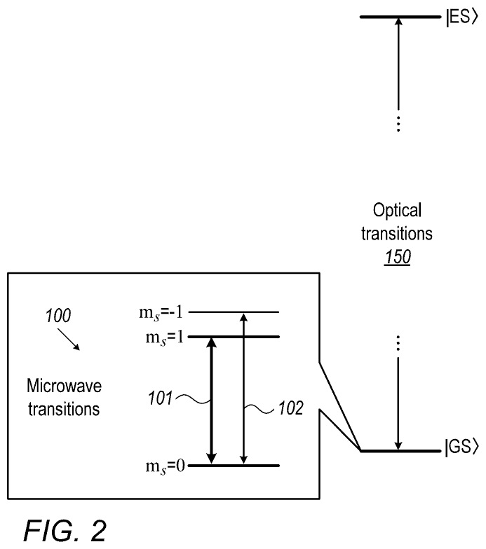

FIG. 2 is a schematic energy level diagram of a qubit(3) prepared in a three-level ground-state |GS> manifold 100, in accordance with an embodiment of the invention. The qubit(3) state can be read optically by measuring an optical property (e.g., intensity, polarization) of a transition from |ES> to |GS>.

In this disclosure, the ground state |GS> includes three spin states mₛ=0, mₛ=1, and mₛ=−1, respectively labeled as |0>, |1>, and |−1>. Such a spin state structure is relevant to many physical realizations of qubits(3), including ions (which typically possess multiple accessible quantum states due to their hyperfine structure) and superconducting circuits (which generally rely on anharmonic levels, allowing access to three levels through appropriately chosen control frequencies).

For example, the qubit(3) is represented in the basis of eigen states of the operator Jₓ:

$${J}_{x} = ( \begin{matrix}0 & 1 & 0 \\ 1 & 0 & 1 \\ 0 & 1 & 0\end{matrix} )$$

The resulting spin states |+ [symbol] and |− [symbol] of the qubit (3) are given as:

$$\vert + 〉 = \frac{1}{\sqrt{2}} \vert 0 〉 + \frac{1}{2} \vert 1 〉 + \frac{1}{2} \vert - 1 〉$$

$$\vert - 〉 = \frac{1}{\sqrt{2}} \vert 0 〉 - \frac{1}{2} \vert 1 〉 - \frac{1}{2} \vert - 1 〉$$

And the qubit(3) |ψ [symbol] is given by:

$$\vert ψ 〉 = α \vert + 〉 + β \vert - 〉$$

The third, |null [symbol] state,

$$\vert null 〉 = \frac{1}{\sqrt{2}} \vert 1 〉 - \frac{1}{\sqrt{2}} \vert - 1 〉 ,$$

is a mode outside the code's base.

In examples in this disclosure, it is assumed that careful coherent control (e.g., using microwave transitions) yields the qubit(3) with states having the same phase for |1 [symbol] and |−1 [symbol] with respect to |0 [symbol] .

Without loss of generality, this disclosure applies the three-level system to atom-like defects in the solid state, such as the nitrogen vacancy (NV) defect in diamond. In the NV system, the |+ [symbol] and |− [symbol] spin states are realized by microwave coherent control fields with well-defined phases, represented by arrows 101 and 102. Coherent control is carried out by phase-locked microwave fields applied at frequencies resonant with the relevant transitions |0 [symbol] ↔|1 [symbol] (101) and |0 [symbol] ↔|−1 [symbol] (102).

As noted above, the qubit(3) spin states |+ [symbol] and |− [symbol] can be read by measuring a property of its optical emission from the optical transition |ES>→|GS> (150), such as its fluorescence intensity and/or polarization.

As noted above, FIG. 2 can be applied to numerous types of quantum systems, where the transition from |ES> to |GS> is detected through various means (e.g., electrical current intensity or phase, magnetic property).

### Quantum Circuit Diagram for Quantum Error Detection Using One or Two Qubits(3)

An error in one or more qubits can be detected by applying a parity operator that checks for any spin flips that occurred without measuring the qubit state, thus performing a nondemolition optical measurement.

The above preparation of the qubit(3) enables the identification of S_{z} errors in the qubit(3), since such errors create a phase flip that leads to a detectable syndrome (states leave the code space):

$$\vert + 〉 ∝ \sqrt{2} \vert 0 〉 + \vert 1 〉 + \vert - 1 〉 {\to }^{{S}_{z} error} \sqrt{2} \vert 0 〉 + \vert 1 〉 - \vert - 1 〉$$

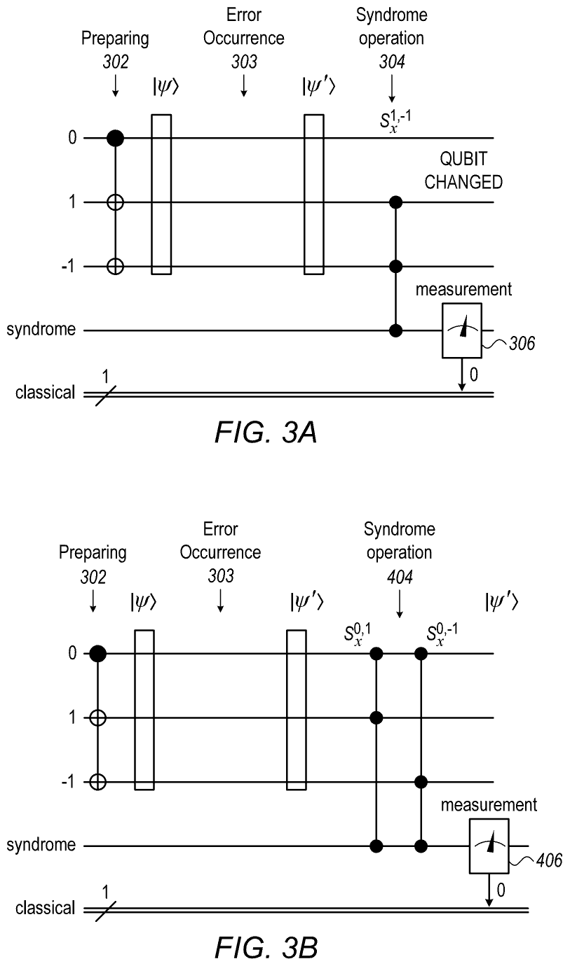

FIGS. 3A and 3B are schematic quantum circuit diagrams illustrating, respectively, single-qubit(3) and two-qubit(3) quantum error detection schemes, in accordance with embodiments of the invention.

As described above, a quantum state |ψ> is provided (e.g., prepared (302)) as |ψ [symbol] =α|+ [symbol] +β|− [symbol] . With time the state may suffer (303) a QE that changes it into an errored state |ψ′>.

To detect if an error has occurred, the parity syndrome used in FIG. 3A may be applied (304) by applying a single operator syndrome

$${S}_{x}^{1 , - 1} ,$$

which result of, when measured, will always be 1 in the code space, but −1 if an error occurred (error being in phase between |0> and |1> or the phase between |0> and |−1> components the qubit(3). This allows for the detection (306) of an error, but not correction (changing the qubit(3)).

This is still useful, as early detection of the error enables an efficient restart of the algorithm, and thus faster operation until success.

The parity syndrome used in FIG. 3B is applied (404) by applying a dual operator syndrome

$${S}_{x}^{0 , 1} {S}_{x}^{0 , - 1} ,$$

which will not alter the qubits(3). This syndrome also always be 1 in the code space, but −1 if an error has occurred. In the above, the assumed phase detected is either 0 or π, but in general any given phase may occur during an error, which using three qubits(3) the disclosed technique will detect and correct.

### Quantum Circuit Diagram for QEC Using Two Qubits(3)

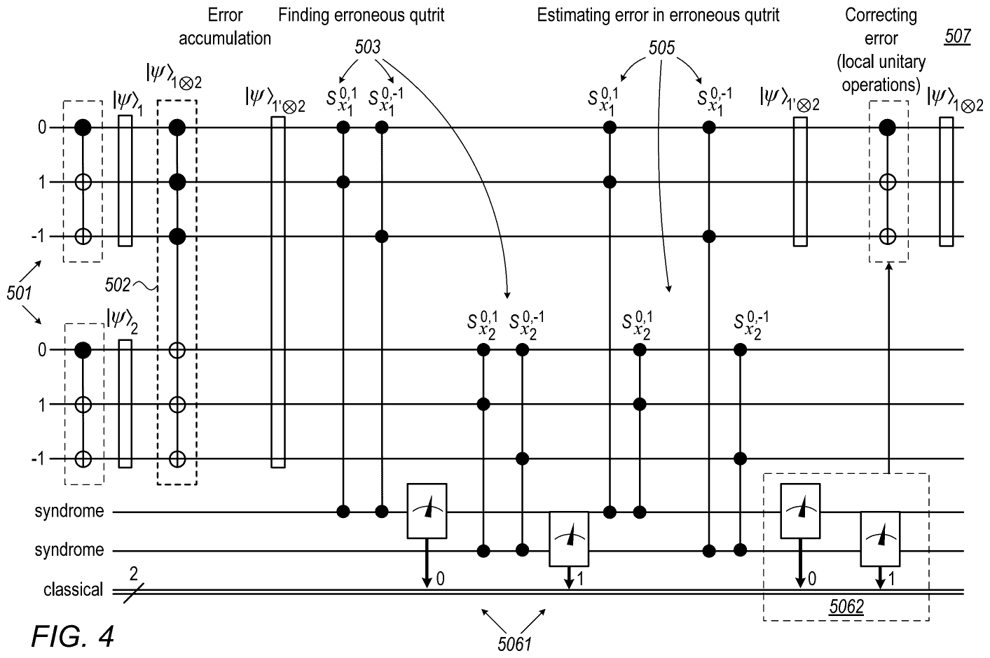

FIG. 4 is a schematic quantum circuit diagram illustrating two-qubit(3) QEC scheme of one kind of error (e.g., spin flip or phase error), in accordance with an embodiment of the invention.

Qubits(3) |ψ>₁ is prepared (501) as super position of the 1+> and |−>. and then |ψ>₁ is entangled into |ψ>₂, to generate (502) an encoded state by the two qubits (3), or |ψ>_{1⊗2}=α|+>₁⊗|+>₂+β|->₁⊗|−>₂ in brief notation, so that a QEC of a single type of quantum error in |ψ>₁ can be performed using only the two qubits(3).

The encoding is performed, for instance, by applying fixed (e.g., DC) magnetic field, and microwave and radiofrequency pulses with the quantum computing device described in FIG. 1.

For the rest of the description, for simplicity the text describes a scenario of the error being in |ψ>₁. The same reasoning applies if the error is found in |ψ>₂.

Syndrome operation blocks 503 and 505, respectively, apply operations (e.g., parity) to the encoded state to check if there is an error in |ψ>₁ and if there is one, to enable a subsequent measurement to estimate its value (how |ψ′>₁ changed into |ψ>₁) without changing |ψ′>₁.

The measurement block 5061 finds which qubit has suffered an error, and block 5062 quantifies the error.

Given the error was quantified, the information from block 5062 allows for the generation of a set of commands (e.g., by a classical processor) that, when implemented as unitary operations, correct |ψ′>₁ to |ψ>₁.

Finally, based on the commands, a QE correction module 508 applies the correction to |ψ>_{1′⊗2} to restore |ψ>_{1⊗2} using microwave and radiofrequency pulses.

### Overview of Detection and Correction of any (QEC) Quantum Error Using Three Qubits(3)

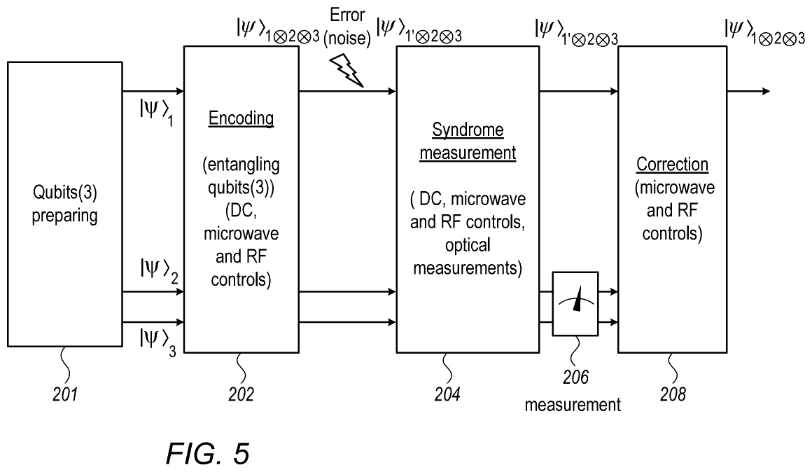

FIG. 5 is a schematic block diagram illustrating a three-qubit(3) QEC scheme of any QE, in accordance with an embodiment of the invention. In FIG. 5, a qubit(3) |ψ>₁ that carries some computational information is a superposition of the 1+> and |−> states described in FIG. 2.

Qubits(3) |ψ>₁, |ψ>₂, are prepared the same (201) as super positions of the |+> and |−>. State |ψ>₃ can be prepared the same or as a qubit(2). State |ψ>₁ is then encoded using two additional qubits(3) or qubit(3) and qubit(2), |ψ>₂, |ψ>₃, to generate (202) an encoded state of the three qubits(3), or two qubits(3) and one qubit(2), or |ψ>_{1⊗2⊗3} in brief notation, so that a QEC can be performed on any quantum error in |ψ>₁ using only the three above qubits(3) or two qubits(3) and one qubit(2).

For the rest of the description, for simplicity the text describes a scenario of the error being in |ψ>1. The same reasoning applies if the error is found in |ψ>₂. or in |ψ>₃.

The entanglement is performed, for instance, by applying a DC magnetic field, and microwave and radiofrequency pulses with the quantum computing device described in FIG. 1.

A syndrome operation block 204 applies a nondemolition operations (e.g., a dual operator syndrome of parity checking) to encoded state |ψ>_{1⊗2⊗3}, to check if |ψ>₁ is correct or not. Specifically, applying an

$${S}_{{x}_{1}}^{0 , 1} {S}_{{x}_{2}}^{0 , - 1} and {S}_{{x}_{1}}^{0 , 1} {S}_{{x}_{2}}^{0 , - 1}$$

operations on the encoded state can identify and allow to estimate the QE.

Applying syndrome measurement block (206) reveals that an error has occurred and the value of the error (how |ψ>₁ changed to |ψ′>₁, giving the errored state |ψ>_{1′⊗2⊗3}).

Given the error was quantified in steps 204-206, the information from block 206 allows to generate a set of commands (e.g., by a classical processor) specifying unitary operations needed to correct |ψ′>₁ to |ψ>₁.

Finally, based on the commands, a correction module 208 applies the correction to |ψ>_{1′⊗2⊗3} to restore |ψ>_{1⊗2⊗3} using microwave and radiofrequency pulses.

### Method for QEC Using Qubits(n)

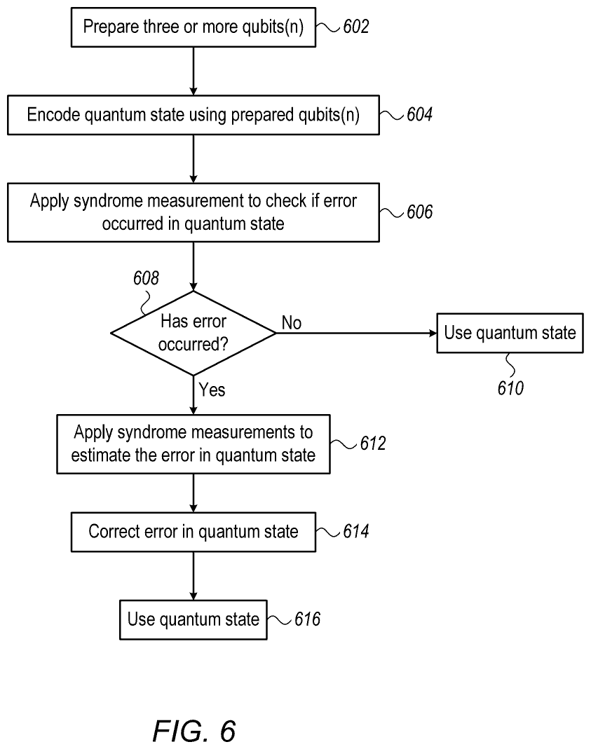

FIG. 6 is a flow chart schematically illustrating a method for QEC using qubits (n), in accordance with an embodiment of the invention. The algorithm, according to the presented example, carries out a process that begins with a quantum processor preparing two or more qubits (n), such as preparing the three qubits(3) shown in FIG. 5, at qubits(n) preparation step 602. In another example described above, two qubits(3) and one qubit(2) are prepared.

At quantum state encoding step 604, the quantum processor encodes a quantum state as |ψ>₁⊗|ψ>₂, using three qubits (3), or as |ψ>₁⊗|ψ>₂⊗|ψ>₃ using three qubits (3), or a higher state using even more qubits (n). In the other example, |ψ>₁⊗|ψ>₂⊗|ψ>₃ is encoded using two qubits (3) and one qubit (2).

Next, the quantum processor applies syndrome measurement to the encoded state to check if an error occurred in the encoded quantum state, at a syndrome applying step 606.

At error checking step 608, a processor checks the answer from step 606 (e.g., parity). If the answer is that no error occurred, the quantum processor may use the quantum state, at quantum state usage step 610.

If the answer indicates that an error has occurred, the quantum processor proceeds to an error measurement step 612, in which it applies additional syndrome measurement to the encoded state.

Using the measured error, the processor applies unitary operations, at a QEC step 614, to the erroneous quantum state, correcting it back into the original encoded state.

The quantum processor may use the corrected quantum state, at quantum state usage step 616.

The process in FIG. 6 is brought as an example. Additional steps may, for example, be performed by a conventional digital processing unit in communication with the quantum processor. The above flowchart describes the correction of one kind of QE. To correct any error (e.g., any phase error), the above procedure can apply two additional qubits(3), |ψ>₂, |ψ>₃, as described in FIG. 5.

### Implementation Example of QEC—NV Center in Diamond

The NV defect consists of an electronic spin 1 (sublevels mₛ=0,±1. It also naturally contains a nuclear spin associated with the nitrogen of the defect. The common nitrogen isotope 14N has a spin 1 nuclear spin (sublevel mₗ=0,±1).

The NV electronic spin can be initialized to the mₛ=|0 [symbol] state by illuminating it optically, within the absorption band (e.g., using λ<637 nm). For example, the initialization may be done by a pulse of laser light (based on an optical pumping process), with a duration determined by the intensity of the laser, and normally ˜0.5 μs at saturation.

The NV electronic spin quantum state can be read out by measuring its fluorescence intensity. Under excitation (with wavelengths described above), the NV fluorescence is red (637-800 nm). The intensity of this fluorescence depends on the electronic spin state of the NV.

Fluorescence intensity from the |0> state is stronger than from the |±1> states. This is due to non-radiative transitions available for the |±1> states.

Fluorescence can be read out for a short timescale (approximately 300 ns, determined by the initialization timescale mentioned above). Thus, a single-shot readout of the electronic spin state is not possible with this simple scheme, and the quantum state of the electronic spin is determined after multiple repetitions of the measurement.

The fluorescence readout naturally provides information on the Sₓ projection of the spin state. Readout of other spin projections is possible by first rotating the spin using microwave fields that act at, or near, the resonance frequency of the spin transition. At zero magnetic field, this resonance occurs at 2.87 GHz.

At a non-zero magnetic field, this resonance is modified by the Zeeman effect, varying by ±3 MHz/Gauss (for the transitions between mₛ=|0 [symbol] and the mₛ=|±1 [symbol] spin sublevels).

Applying microwave fields with given strengths and durations (the product of which is called area) can create any desired rotation in the corresponding spin space. Standard rotations include a π area rotation around the x-axis, which can flip between the mₛ=|0 [symbol] state to the mₛ=|1 [symbol] state (which can of course be extended to rotations around another axis and with different resonance, e.g. to rotate to the |−1 [symbol] state). A π/2 area rotation can create a superposition state, e.g., |0 [symbol] +|1 [symbol] .

A combination of resonant microwave controls can create any desired state in the three-level system. Combined and phase-locked resonant drives coupling both |0 [symbol] →|1 [symbol] and |0 [symbol] →|−1 [symbol] can create the code space stated above in FIG. 2, with a qubit's (|+ [symbol] ∝\sqrt{2}|0 [symbol] +|1 [symbol] +|−1 [symbol] and |− [symbol] ∝\sqrt{2}|0 [symbol] −|1 [symbol] −|−1 [symbol] ).

The nuclear spin associated with the nitrogen in the NV center can serve as a memory, enabling readout (and syndrome detection) as described above. The coupling between the nuclear and electronic spins (hyperfine coupling, nominally ˜2.3 MHz for the 14N system) enables control and driving of these spins, as well as creating entanglement between them, which is necessary for the memory and readout schemes. The nuclear spin state can be initialized by combining this driving with the initialization of the electronic spin.

The nuclear spin is driven by radiofrequency (RF) fields that are applied at the resonance frequencies associated with the relevant nuclear sin transition.

In the manifold of mₛ=|0 [symbol] , the nuclear 0 state is split from ±1 by a quadrupolar field of ˜5 MHz. An additional Zeeman shift of the ±1 nuclear states appear but are small due to the small gyromagnetic ratio of 14N (of ˜0.4 kHz/Gauss). In the other manifolds, an additional shift is associated with the hyperfine coupling mentioned above. For example, for mₛ=|1 [symbol] the mₗ=|±1 [symbol] are shifted by ±2.3 MHz respectively.

Driving a π pulse on the NV electronic spin, such as between states |0> and |1>, at the resonance associated with the nuclear spin state 1 (which differs from the resonance for the other nuclear spin states), entangles the electronic and nuclear spin states, and acts as a form of the commonly used controlled-NOT (CNOT) gate, flipping the electronic spin from 0 to 1 only if the nuclear spin is at 1.

Now, driving a π pulse using RF fields resonant with the nuclear 1 to 0 transition frequency in the electronic 1 state will flip the nuclear 1 population to 0 (while the electronic spin is at 1).

A laser pulse for electronic spin initialization (as described above) will pump the electronic spin state to 0, with the nuclear spin state now at 0 or −1 (the 1 state having been driven to 0). This process is repeated, now utilizing microwave and RF pulses resonant with driving the electronic spin from 0 to 1, given a −1 nuclear spin state, and driving the nuclear spin from −1 to 0 in the electronic spin 1 manifold. This further pumps the system from nuclear spin state −1 to 0, resulting in complete initialization of the nuclear spin state to 0.

After initialization, CNOT gates can be applied (as described above) to entangle and map the electronic spin state to the nuclear spin state, creating a memory. This memory is necessary for the scheme to enable the readout of the quantum state (syndrome), to check for errors and to correct errors (as described above).

At any point in time, the state of the electronic spin (the qubit(3)) is mapped to the nuclear spin (as described above) to enable the readout. The readout is performed by mapping the nuclear spin state back to the electronic spin state and reading it. Since the readout is not perfect, this must be repeated several times, eventually achieving a “single-shot readout.”

The readout of the Sₓ operator, as described above, will identify the error and enable correction for a two-qubit(3) system.

Errors are corrected on the electronic spin using resonant microwave fields, as described above, to achieve the necessary phase correction.

### Extension to any Quantum Error Correction

Increasing the number of qubits(3) to three enables identification and correction of any error (not just S_{z}).

To this end, the 1^{st} and 2^{nd} qubits(3) are entangled in the {|+>, |−>} basis, as in FIG. 4, while the 1^{st} and the 3^{rd} qubits are coupled in a {|0>, |1>} basis generated by a Hadamard shift with respect to {|+>, |−>} basis.

Using the above encoding, any Sₓ or S_{y} error will take us out of the code base into the error base, allowing us to identify an error

For example, an

$${S}_{x}^{01}$$

error will flip |0 [symbol] to |+1 [symbol] (which is not in the code base). Or if one started in |+1 [symbol] +|−1 [symbol] to |0 [symbol] +|−1 [symbol] , which is also not in the code base.

Once an error is detected, it can be corrected according to the actual state known from the other two qubits (3).

### Other Implementations

The disclosed approach is relevant for any system in which a qubit(n) can be realized with lower overhead compared to a qubit(2).

For example, superconducting qubits are created in an effective nonlinear oscillator system, singling out two levels from the many available states. Utilizing three levels to form a qubit(3) is readily feasible.

For trapped ions, the hyperfine structure nominally includes many relevant sublevels. Addressing three levels to form a qubit(3) is a natural extension in many cases. It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for quantum error handling, comprising:
preparing one or more qubits in respective n-level quantum systems, n≥3;
measuring a quantum property of the one or more qubits; and
detecting an occurrence of some quantum error in the one or more qubits using the measured property.

2. The method according to claim 1, and comprising:
encoding a logical qubit using two or more of the qubits;
measuring a single type quantum error in the logical qubit; and
applying a correction to the single type quantum error in the logical qubit.

3. The method according to claim 1, and comprising:
encoding a logical qubit using three or more of the qubits;
measuring any type of quantum error in the logical qubit; and
applying a correction to the quantum error in the logical qubit.

4. The method according to claim 3, wherein detecting and measuring an error in the logical qubit comprises applying a parity syndrome to the logical qubit.

5. The method according to claim 3, and comprising, using classical computing circuitry, outputting a measurement result of the quantum error, and specifying correction operations required to correct the measured quantum error.

6. The method according to claim 1, wherein the n-level systems are three-level systems of a ground state of a diamond NV center.

7. The method according to claim 1, wherein preparing the one or more qubits comprises using coherent control with microwave pulses.

8. The method according to claim 1, and comprising, using coherent control, storing the qubits using a nuclear spin based quantum memory.

9. The method according to claim 1, and comprising:
encoding a logical qubit using two of the qubits and one qubit prepared in a two-level system;
measuring any type of quantum error in the logical qubit; and
applying a correction to the quantum error in the logical qubit.

10. A system for quantum error handling, comprising:
a first circuitry configured to prepare one or more qubits in respective n-level quantum systems, n≥3; and
a second circuitry configured to:
measure a quantum property of the one or more qubits; and
detect an occurrence of some quantum error in the one or more qubits using the measured property.

11. The system according to claim 10, wherein the first circuitry is further configured to encode a logical qubit using two or more of the qubits, and wherein the second circuitry is further configured to:
measure a single type quantum error in the logical qubit; and
apply a correction to the single type quantum error in the logical qubit.

12. The system according to claim 10, wherein the first circuitry is further configured to encode a logical qubit using three or more of the qubits, and wherein the second circuitry is further configured to:
measure any type of quantum error in the logical qubit; and
apply a correction to the quantum error in the logical qubit.

13. The system according to claim 12, wherein the second circuitry is configured to detect and measure an error in the logical qubit by applying a parity syndrome to the logical qubit.

14. The system according to claim 12, further comprising classical computing circuitry configured to output a measurement result of the quantum error, and specify correction operations required to correct the measured quantum error.

15. The system according to claim 10, wherein the n-level systems are three-level systems of a ground state of a diamond NV center.

16. The system according to claim 10, wherein the first circuitry is configured to prepare the one or more qubits by using coherent control with microwave pulses.

17. The system according to claim 10, wherein the first circuitry is further configured to, using coherent control, store the qubits using a nuclear spin based quantum memory.

18. The system according to claim 10, wherein the first circuitry is further configured to encode a logical qubit using two of the qubits and one qubit prepared in a two-level system, and wherein the second circuitry is further configured to:
measure any type of quantum error in the logical qubit; and
apply a correction to the quantum error in the logical qubit.
